(19) United States
(12) Patent Application Publication
(10) Pub. No.: US 2008/0048453 A1
(43) Pub. Date: Feb. 28, 2008

(54) Tethered Wind Turbine

(76) Inventor: Douglas J. Amick, Troy, MI (US)

Correspondence Address: KENYON & KENYON LLP, RIVERPARK TOWERS, SUITE 600, 333 W. SAN CARLOS ST., SAN JOSE, CA, 95110, US

(21) Appl. No.: 11/830,769

(22) Filed: Jul. 30, 2007

Related U.S. Application Data
(60) Provisional application No. 60/834,518, filed on Jul. 31, 2006.

(51) Int. Cl. F03D 9/00; F03D 7/04; F03D 9/02

(52) U.S. Cl. 290/44; 290/55; 415/2.1

(57) ABSTRACT

The tethered wind turbine uses an aerodynamic, flow-concentrating shape and lighter-than-air construction utilizing a lifting gas and an electrically conductive tether fixed to ground to reap energy from the wind at low or high altitude. The design has no need for the large, expensive, bulky and unsightly tower structures, pivoting nacelles, or gearboxes presently used in conventional horizontal axis windmills. The tethered wind turbine of this invention easily and passively floats aloft downwind to a direction and position that is aligned with the wind. The invention uses sensors and control modules to fly gracefully at an optimal altitude in most wind regimes and also to ascend/descend when appropriate to seek shelter from extreme weather conditions. Ideally, the tethered wind turbine of this invention would utilize carbon nanotube materials in its tether for both structural and conductive purposes. The ring-wing section profile in the preferred embodiment of this invention optimally would have a very low coefficient of drag. A major benefit of this invention is potentially much lower cost per installed kilowatt capacity and a lower operating cost per kilowatt hour delivered to the end user.

This application claims the benefit of priority from provisional application No. 60/834,518 filed on Jul. 31, 2006.

### BACKGROUND

This invention called “Tethered Wind Turbine” relates to wind powered devices that generate energy from the wind, specifically to windmills that are deployed at or above ground or sea level. However, in another embodiment, this invention could also be used to generate energy from undersea water currents, being more appropriately called a tethered underwater current turbine energy generator.

Windmills in recent years have become more effective and competitive with other energy sources, but most still remain very expensive to install and maintain. As a result, their overall cost per installed kilowatt hour is still high enough that they are only marginally deployed and they contribute only a small amount to the electrical grid. The primary method modern windmills use today is a horizontally-mounted, large diameter, three-bladed propeller that rotates at low revolutions-per-minute over a very large swept area. The higher the rotational axis of the propeller can be mounted, the better. The natural speed of the wind increases proportionally with an increase in the height above the ground. Conventional windmills have very tall and very strong tower structures. Typically they have a tubular steel tower that is mounted to a deep below ground cement base. The system has to be very carefully engineered and sited appropriately for the surrounding terrain. The towers must maintain a central stairway or other means to allow construction and operator access to the upper mechanicals. The tower must accommodate the heavy gearbox, electrical turbine, and propeller assembly, as well as be strong enough to withstand gale force winds, and potentially earthquakes. To make the system even more complicated, the upper nacelle and gearbox/turbine housing must be able to pivot on a vertical axis, so as to align the propeller correctly with the wind direction at any time during the day or night. On many windmill systems the individual blades of the windmill are able to rotate about their individual longitudinal axis, for pitch control. They can optimize the pitch of the blades depending on the nominal wind speed conditions that are present at any one time at the site. They can also change the pitch of the blade to “feather” the propeller if the nominal wind speeds are too large. Occasionally the windmill is locked to prevent rotation, and the blades feathered to prevent major damage to the machine in a storm. All of this pitch control technology adds significantly to the cost of windmills. Another major problem with conventional windmills is damage caused by lightning during thunderstorms. The blades can be upwards of 300 feet in the air and are a good source for lightning to find a conductive path to the ground. Some of the more recently designed windmills use a system of replaceable sacrificial lightning conduction attractors that are built into each windmill propeller blade. They help channel the lightning away from the vulnerable composite structure that comprises the blade itself. The fact remains that one of the major causes of windmill downtime and maintenance costs are caused by lightning damage. The size of many windmills is also a major problem for inspection, diagnostics, and repair. Often workmen have to use ropes and climbing techniques to perform maintenance on the massive machines. It is very expensive and dangerous. In recent years workmen have fallen to their death trying to repair the blades. In conclusion, insofar as I am aware, no current windmill provides competitively inexpensive energy generation without the major defect of highly priced support tower construction and maintenance costs coupled with high risk diagnosis and repair of the large windmill blades themselves.

### SUMMARY

The invention, an improved windmill, is a special design that combines a lighter-than-air structural design with an aerodynamic shape that concentrates the wind's forces through a relatively-higher-RPM yet smaller-diameter turbine generator, thus eliminating the need for a fixed tower. The lighter-than-air machine is tethered to the ground and can therefore freely align itself optimally with the direction of the prevailing wind automatically and with no loss in efficiency. The tether also provides the conductive path for the wind turbine's electrical energy to travel down to the base station where it can enter the grid or be used locally. In one embodiment, the system employs ultra-low weight onboard weather diagnostic computer technology to be able to smartly know when to remain aloft, and when to robotically be retracted and returned to the base shelter to wait-out a potentially destructive storm. This feature would effectively eliminate the lightning damage problem of current windmills.

Several advantages of the invention are to provide an improved windmill, to provide a means of reducing the cost of wind generated electrical energy, to provide a wind generator with much reduced installation costs, to provide a wind generator with much reduced problems associated with maintenance, bird and bat kills, and downtime due to lightning damage, and to provide a low cost windmill design that is scaleable and that could be affordable and practical for individual home owners and small community cooperatives, as well as an attractive alternative to fossil fuels for large energy companies to use in their electric grid operations. An additional objective would be to produce an embodiment of the invention that would perform well underwater as a lighter-than-water, tethered, sea-current turbine generator.

### BRIEF DESCRIPTION OF THE DRAWINGS

FIG. 1 is a perspective left-side view of a tethered wind turbine constructed in accordance with the invention, showing primarily the left half of the funnel-shaped wind turbine.

FIG. 2 is a perspective right-side view of the tethered wind turbine of FIG. 1.

FIG. 3 is a longitudinal cross-sectional view of the wind turbine of FIGS. 1 and 2, showing the fluid flow, internal turbine parts, and control module.

FIG. 4 is a perspective front view of the wind turbine of FIGS. 1 and 2, showing an embodiment that uses a rear mounted vertical wing stabilizer.

FIG. 5 is a perspective left-side view of the wind turbine of FIGS. 1 and 2, showing an embodiment of the invention that uses one combination of rear wing stabilizers and forward mounted lifting wings to improve stability and performance.

FIG. 6A is a perspective left-side view of the tethered wind turbine of FIGS. 1 and 2 that shows it in operation at a medium height, being tethered to the base structure on the ground.

FIG. 6B is a perspective left-side cutaway view of the invention of FIGS. 1 and 2 showing the typical base structure with the hanger doors open and the tethered wind turbine retracted to the top of the main pulley.

FIG. 6C is a perspective left-side cutaway view of the invention showing the typical base structure with the hanger doors closed and the tethered wind turbine fully captured for ground storage.

FIG. 6D is a perspective left-side detail view of the tether component of the invention of FIGS. 1 and 2 showing its typical construction.

FIG. 7A, 7B, 7C are longitudinal cross-sectional views of the wind turbine of FIGS. 1 and 2, showing the harness pitch retractor at various adjustments, and the resultant aerodynamic pitch angle of the tethered wind turbine invention.

FIG. 8A is a perspective left-side view of the tethered wind turbine of FIGS. 1 and 2 that shows how in one embodiment of the invention a simple tubular tail boom (110) could be used to mount rear wing surfaces such as vertical stabilizer (52) and horizontal stabilizer (56).

FIG. 8B is a longitudinal cross-sectional view of the wind turbine of FIGS. 1 and 2, showing how the fluted tail section (112) could be built to allow outlet air (114) to exit through slots in the tail boom section itself.

FIG. 9A, 9B, 9C, 9D are longitudinal cross-sectional views of the wind turbine of FIGS. 1 and 2, showing how potentially many different section shapes of the gas inflated structure could be used without materially diverging from the scope of this invention.

### DETAILED DESCRIPTION

Detailed descriptions of one or more embodiments of the invention follow, examples of which may be graphically illustrated in the drawings. Each example and embodiment are provided by way of explanation of the invention, and not meant as a limitation of the invention. For example, features or described as part of one embodiment may be utilized with another embodiment to yield still a further embodiment. It is intended that the present invention include these and other modifications and variations.

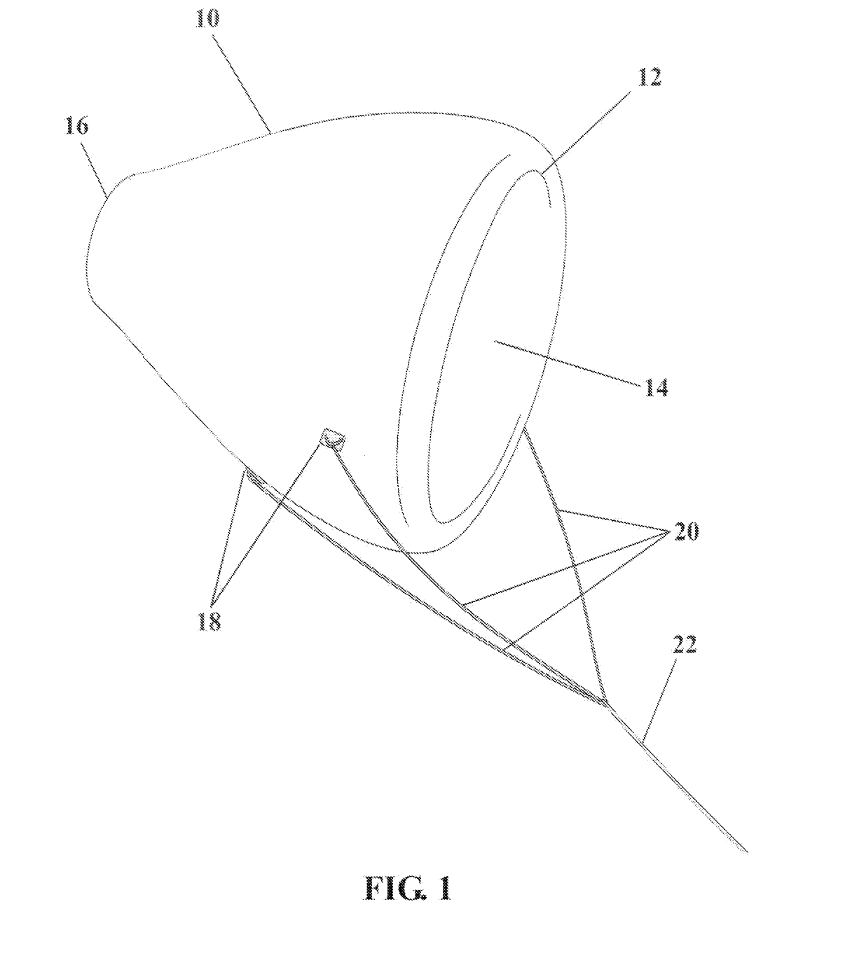

FIG. 1 is a perspective view taken from the left side from the ground standing upwind of the tethered wind turbine constructed in accordance with the invention. The funnel shaped front inlet (14) is shaped with an annulus (12) that directs the oncoming apparent wind into the interior. The lighter-than-air device is passively stabile. It has an elongated airfoil shape. Stability is facilitated by, but not limited to, the overall shape of the lighter-than-air device, or in one embodiment, passive stabilizer aerodynamic surfaces such as non-articulating horizontal, vertical, v-shaped or ring-wing stabilizers. A lower portion of the invention has attachment brackets (18) that are used to connect the harness (20) and tether (22) to the main body casing (10). Large quantities of wind pass through the inlet (14), the turbine area of the tethered wind turbine, finally exiting the invention through the outlet (16). The energy harvesting invention is lighter than air and thus remains aloft in various wind conditions.

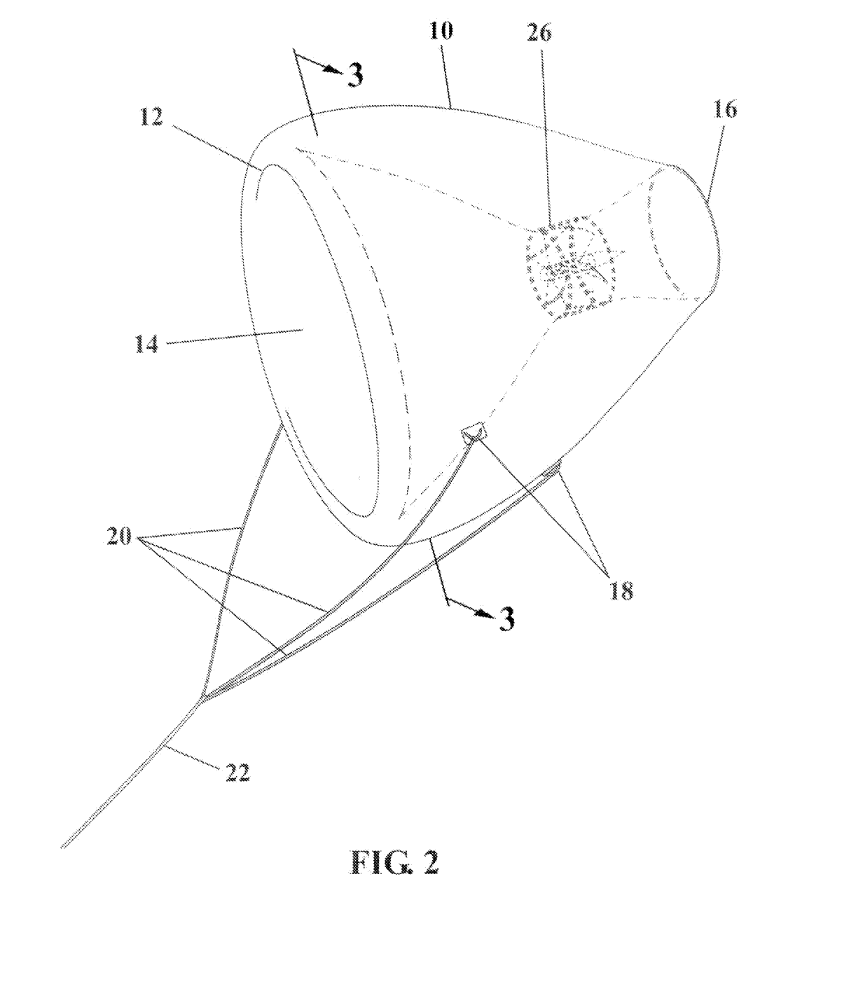

FIG. 2 is a perspective view taken from the right side from the ground standing upwind of the tethered wind turbine constructed in accordance with the invention. The wind entering the inlet (14) passes over the energy converter. Energy extraction is facilitated by an energy converter such as and for example a turbine (24) or an impeller rotor (26) or the like. In this embodiment turbine (24) is shown near the narrowest part of the hourglass-like internal shape.

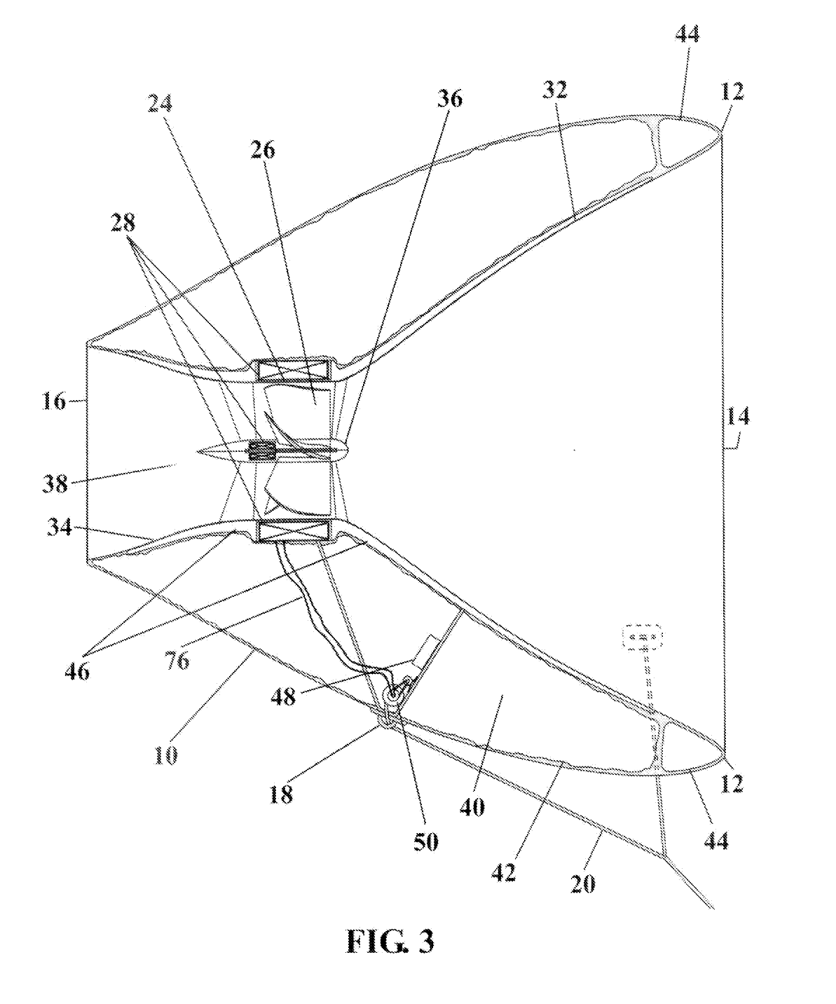

FIG. 3 is a longitudinal cross sectional view of the tethered wind turbine drawn in accordance with the invention. Both the interior and exterior surface profiles, as shown in this view, are designed to be as aerodynamically efficient as is feasible. In the preferred embodiment of this invention the ring-wing section profile optimally would have a very low coefficient of drag. A large portion of the physical aerodynamic shape of the tethered wind turbine is filled with a lifting gas (40), such as helium. This lifting gas is contained within sealed inflated structures (42) made from polymers such as aluminized polyester film, polyethylene, or other film. The entire tethered wind turbine may also use an exterior lightweight flexible or lightweight rigid exterior skin to act as a shape structure and to protect the tethered wind turbine from the deteriorating effects of ultraviolet solar radiation. One flexible film that would work well for this purpose in this invention is Tedlar (DuPont) film. A rigid material for the exterior could be composite material such as carbon fiber matrix or carbon nanotubes matrix. The tethered wind turbine has an intake flow concentrator nozzle (32) just to the interior of the leading edge annulus (12). There is a flow expansion nozzle (34) at the outlet (16) of the invention. Between the concentrator and expansion nozzles there is an energy converter such as and for example a turbine (24) that energizes an electric generator (28). It is also envisioned, though not shown, that other types of energy converter devices could be used. For example, one concept envisioned in this invention is to directly convert the rotary motion into electricity and use it onboard the tethered wind turbine to separate water into hydrogen and oxygen through electrolysis, delivering the valuable gases to the ground station through a tubular tether (or a multi-tubular tether), without any conductive wires at all. The hydrogen could be stored in containment vessels on the ground and used for any number of useful purposes.

The structure of the tethered wind turbine is achieved by several elements. The structural ribs (46) support the overall shape of the tethered wind turbine and spread the loads of the turbine's (24) and generator's (28) mass into the craft in a stable manner. In one embodiment, a light weight way to create the structure of the annulus (12) is shown, using an inflated toroidal structure (44) that is filled with pressurized lifting gas (40). There are many ways to achieve the necessary structure, and what is shown is meant to be an example of one embodiment of the invention. The rotor impeller (26) is fitted with a streamlined impeller nosecone (36) and impeller tail cone (38). The electric generator (28) can be any combination of magnetic rotor or magnetic stator designs, either brush or brushless, and made of a variety of materials. The preferred embodiment would use ultra-light-weight rare earth permanent magnets with brushless DC components and windings that could possibly consist of carbon nanotube hyper-conductive wires in place of copper to save even more weight. There are conductive generator output wires (76) connecting the generator to the harness (20). The harness (20) is secured to the tethered wind turbine at attachment brackets (18). Said attachment brackets (18) could be hard mounted to the internal structure or physically attached or bonded to the outer skin of the tethered wind turbine. The harness (20) can be rigidly attached, or mounted in such as was as to allow controllable adjustments by mechanical servo-actuators. One embodiment of this feature, a harness pitch adjustor (50), is shown and is a way to control the tethered wind turbine's angle of attack by lengthening or shortening the central member of a three point harness (20). The control box (48) is the central brain for the onboard functionality of the tethered wind turbine, controlling such as the harness pitch adjustor (50), the flight settings, the generator loading, and any aerodynamic control surfaces, etc.

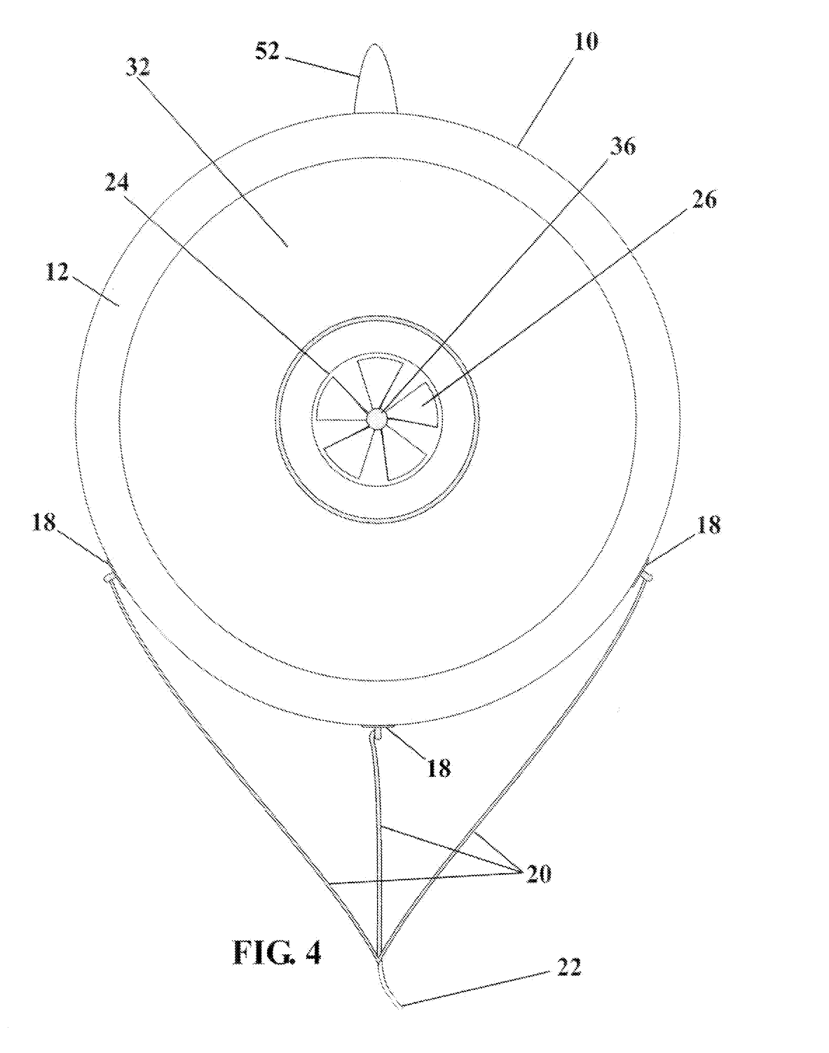

FIG. 4 is a perspective front view of the tethered wind turbine and shows an embodiment of the invention that includes a vertical stabilizer (52) mounted at the top and to the rear of the craft. The full front of the impeller rotor (26) and impeller nose cone (36) are visible and are described visually as having 5 blades. Any number of impeller rotor (26) blades would be acceptable and part of the intent of this invention. The outer casing (10) of the lighter-than-air is shown, as well as the flow concentrator nozzle (32) and the annulus (12). Attachment brackets (18) secure the harness (20) to the tethered wind turbine. The harness (20) is also shown secured to the tether (22).

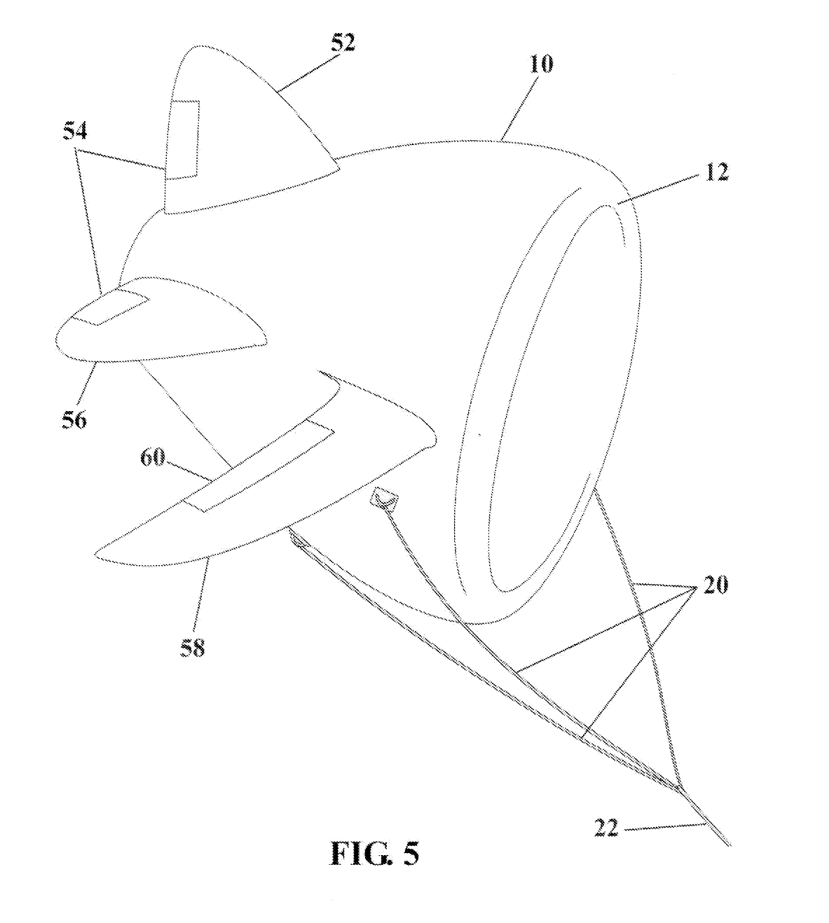

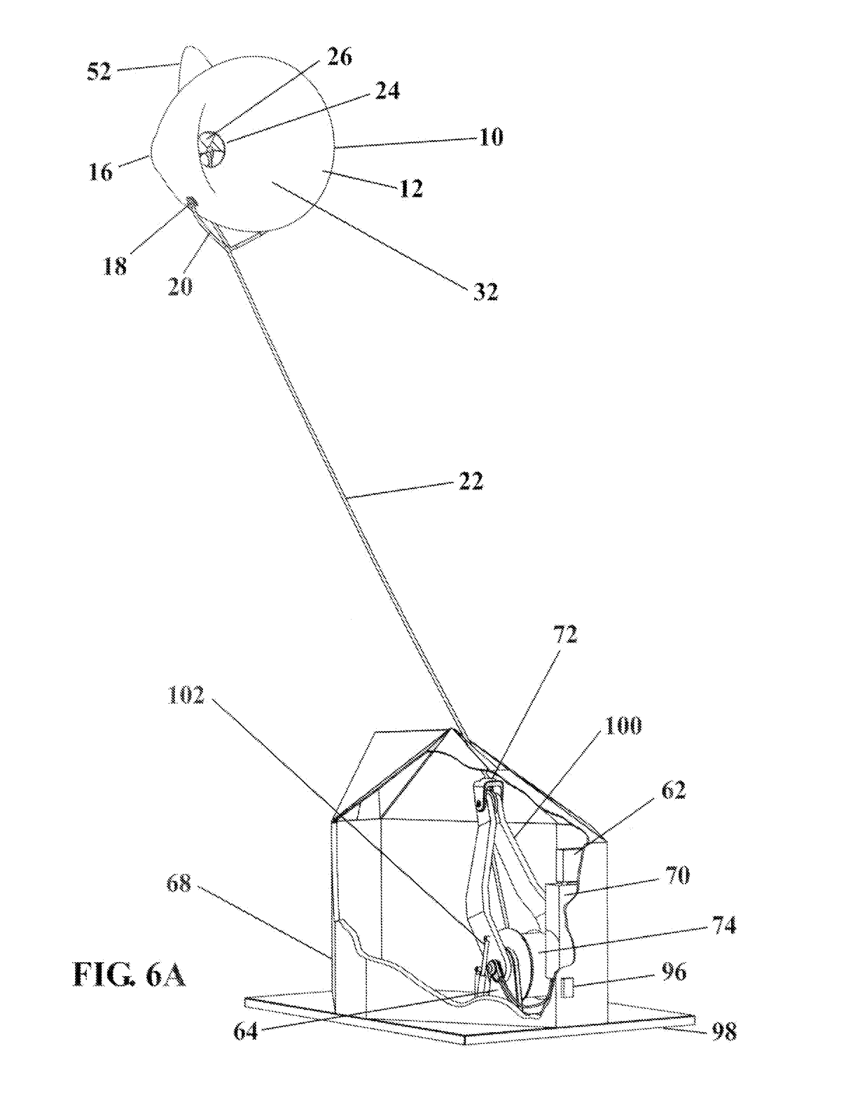

FIG. 5 is a perspective left side view of the tethered wind turbine. Showing an embodiment built in accordance with the invention that uses a number of aerodynamic lifting and control surfaces to enhance the overall stability and performance of the wind energy extracting craft. Vertical stabilizer (52) and horizontal stabilizers (56) act to further help keep the longitudinal axis of the turbine (24) aligned with the apparent wind direction. These aerodynamic surfaces can be either passive, or actively controlled with the use of stabilizer control surfaces (54). A wing (58) is shown in this embodiment and can add additional lift to the tethered wind turbine to help it remain at altitude even when the wind conditions attempt to blow the craft downwind and downward. Wing control surfaces (60) are shown and help control roll as needed. These control functions are envisioned to be fully controlled by the onboard control module (48).

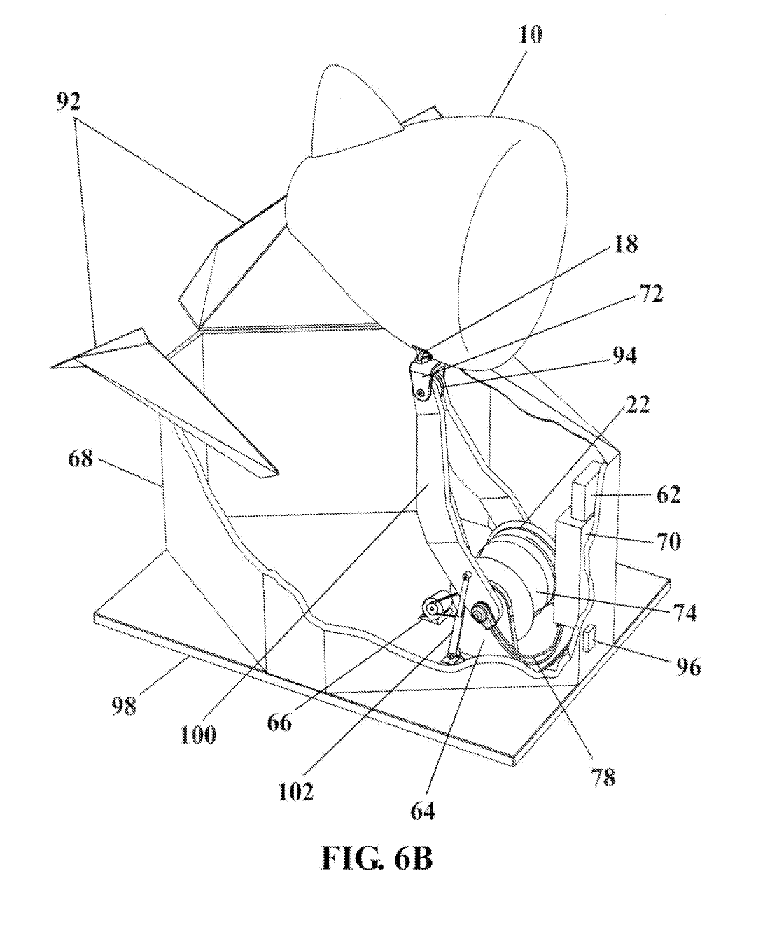

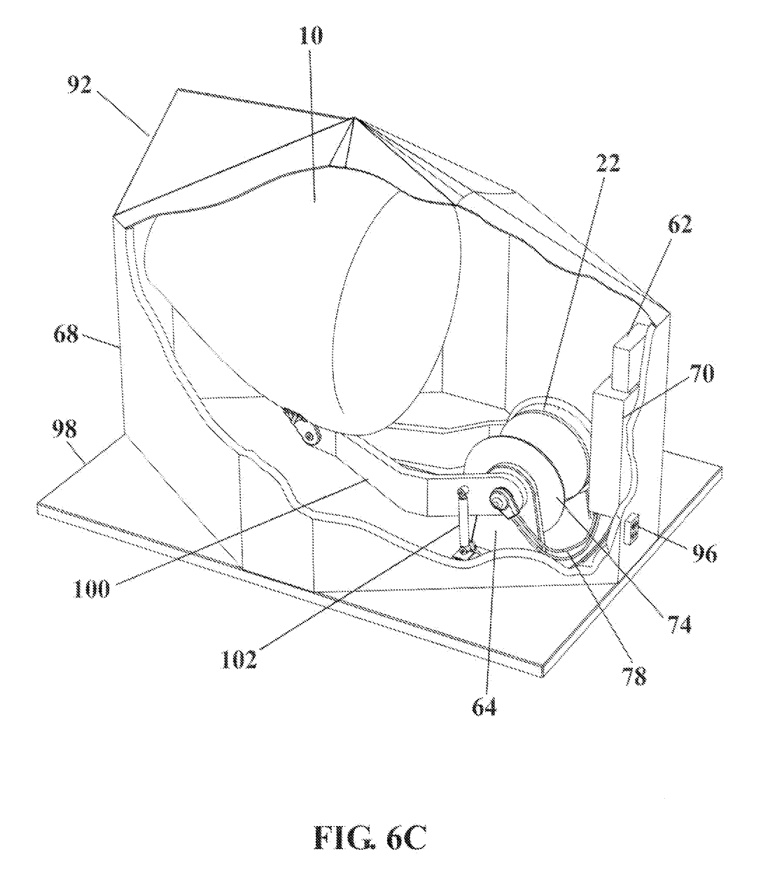

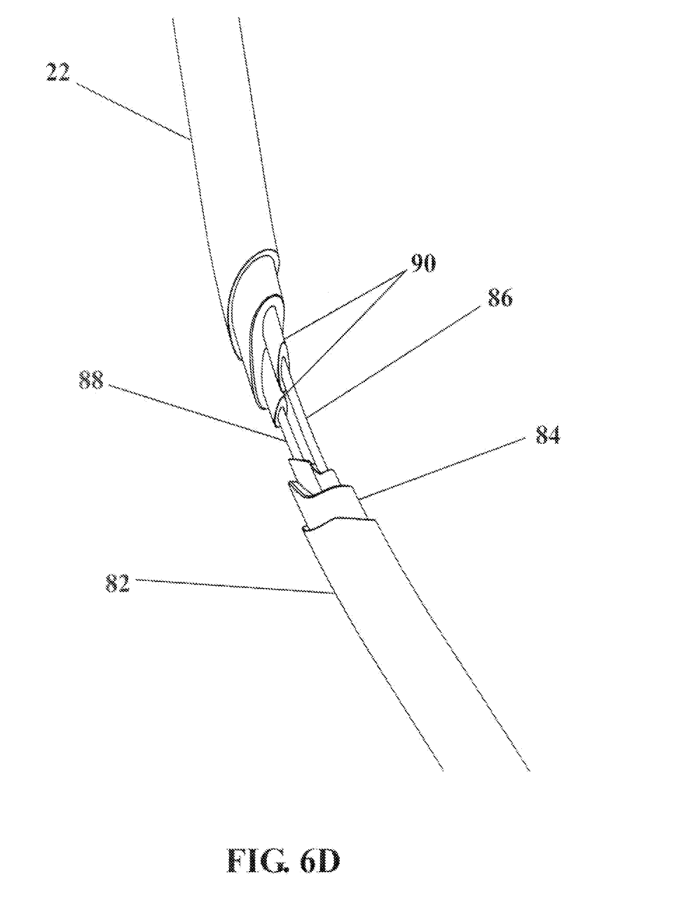

FIGS. 6A, 6B, and 6C show the tethered wind turbine as a system that is managed from a base shelter structure (68). This base shelter structure (68) would be pre-built and carried to the site or it could be built on the site. It would also be installed atop housing or buildings or concealed below grade.

FIG. 6A is a left-side perspective with cutaway view of the tethered wind turbine and base shelter structure (68) showing the invention in operation. The tethered wind turbine is flying at a reasonable height above the ground, downwind of the base shelter structure (68), and is constrained by the tether (22). The craft can be expected to float freely downwind in any direction as a result of changes in true wind direction. The total airspace occupied by the tethered wind turbine in the long term can be described as an inverted cone emanating from the tether main attachment at the robotic control torus (72). The top diameter and half angle of the inscribed cone is dependent on many variables such as the total buoyancy force of the invention, maximum wind speed, amount of active flight controls used to maintain altitude, and active tether extension/retraction deployed, and turbine generator load levels. To send the tethered wind turbine to a higher or lower altitude while in flight, the tether (22) is unwound or wound-up on the tether retractor reel (74) by the tether retractor mechanism (64). The cutaway view of the base shelter structure (68) also shows a wish-bone launch arm (100) that swings up when the tethered wind turbine is about to be launched and also swings down when the craft is retrieved and tucked into the base shelter structure (68) for safe storage. This wish-bone launch arm (100) mechanism may be shaped differently, such as having one leg instead of the wish-bone shape, but all versions act as a lever to initially move the tethered wind turbine up out of the base shelter structure (68) or down within the its walls. The entire base shelter structure (68) sits on a site pad (98).

FIG. 6B is a perspective cutaway view of the tethered wind turbine near the middle phase of the launching process, or the retrieving for storage process. In the latter, the tethered wind turbine has been pulled down out of the sky to a point where the harness (20) touches and interacts with the robotic control torus (72). It shows the base shelter structure (68) with its hinged bay doors (92) opened wide. The wish-bone launch arm (100) is in the upright position and the launch arm actuators (102) are fully extended. Energizing the reel motor (66) causes the rotation of the tether retraction reel (74), which is bi-directional in this embodiment of the invention. It rolls the tether retraction reel (74) in one direction to wind-up (retract) the tether (22) and rotates the reel in the opposite direction to unwind the tether (22), allowing the buoyant tethered wind turbine to ascend upward into the airspace above. The control of the reel motor (66) is accomplished with the logic that is built into the retractor control module (62). Also shown are the reel-to-power box cables (78) that deliver electricity from the tether (22) to the power control/conditioning box (70) where the electrical characteristics are tailored to meet desired output specifications of a particular application. Power from the tethered wind turbine invention is delivered to the end use through the output plug box (96).

FIG. 6C is a perspective left-side cutaway view of the entire tethered wind turbine and base shelter structure (68) as a system that has been put into the storage mode where the inflated casing (10) and other components are safe from excessive weather conditions such as lightning, turbulent high winds, and wintry blizzards. In this state, the tether (22) is fully wound-up by the tether retractor mechanism (64) onto the tether retractor reel (74). The wish-bone launch arm (100) is in the lower position and the launch arm actuators (102) are fully retracted. The hinged bay doors (92) are shown in the closed position. Meteorological sensors (104) on the base shelter structure (68) monitor the air-space and keep the tethered wind turbine safely contained until conditions are appropriate for launching in the future.

FIG. 6D is a perspective detail view of the tether (22) itself. Within the outer casing (82) of the tether are two critical components. They are the main tensile members (84) and the electrical wires. Both the positive conductor wires (86) and negative conductor wires (88) are sheathed in an insulation jacket that prevents short-circuiting and power drainage. Ideally, the main tensile members (84) and the positive conductor wires (86) and negative conductor wires (88) would be comprised of carbon nanotubes materials. Although these materials are not a requirement, the use of carbon nanotubes materials in these components of the tether (22) would greatly enhance the overall performance of the tethered wind turbine. That is because the tether (22) itself is a parasitic weight loss acting against the tethered wind turbine's buoyancy. Carbon nanotube materials would make the tether (22) itself many times lighter and allow the tethered wind turbine to fly much higher using less lifting gas (40). Electrical conductance of nanotube wires would be many times higher than copper and would enhance overall efficiency greatly. In lieu of carbon nanotubes materials, many other materials would also work well. Some examples are copper core conductors, Spectra™ fiber tensile members, Kevlar™ fiber tensile members, or polyester fiber tensile members.

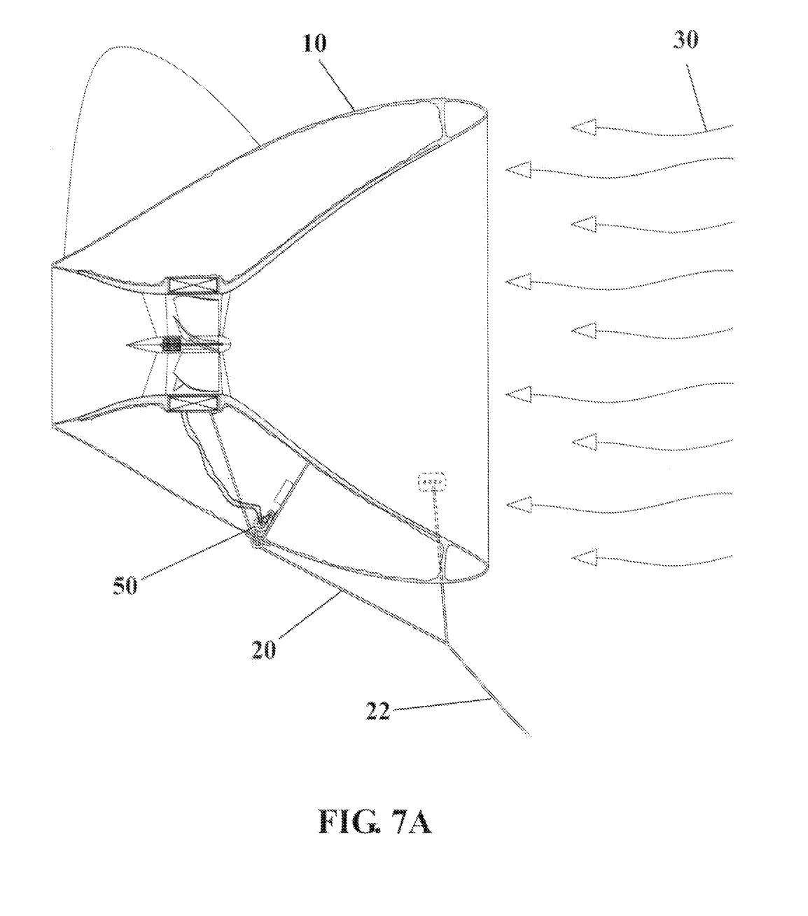

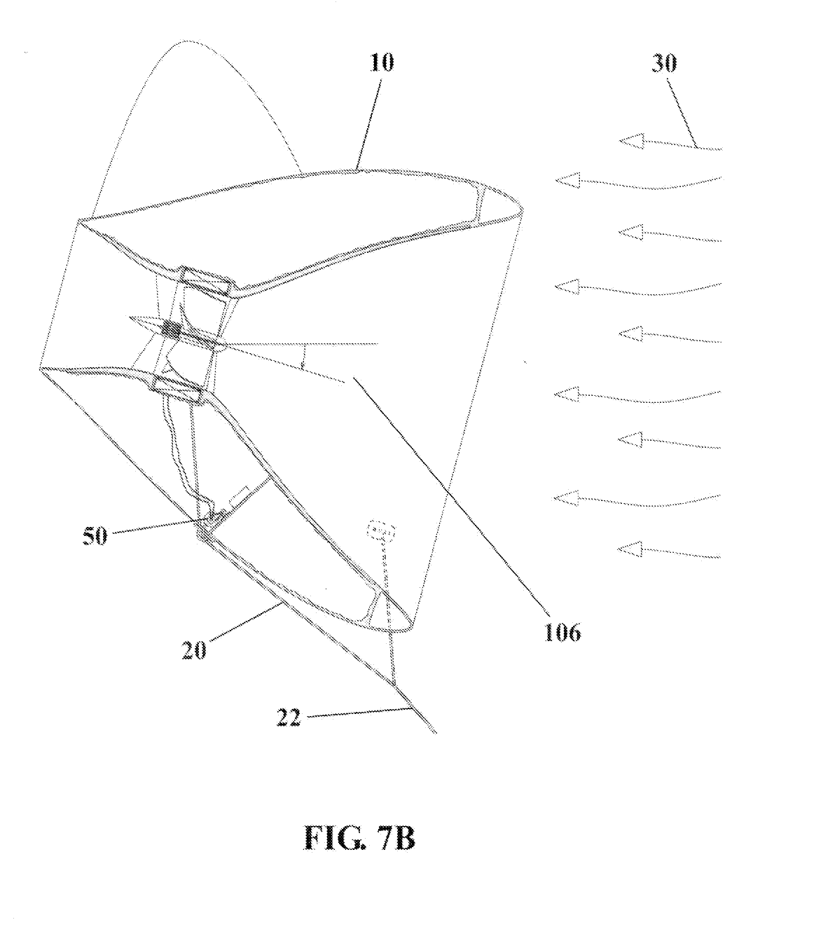

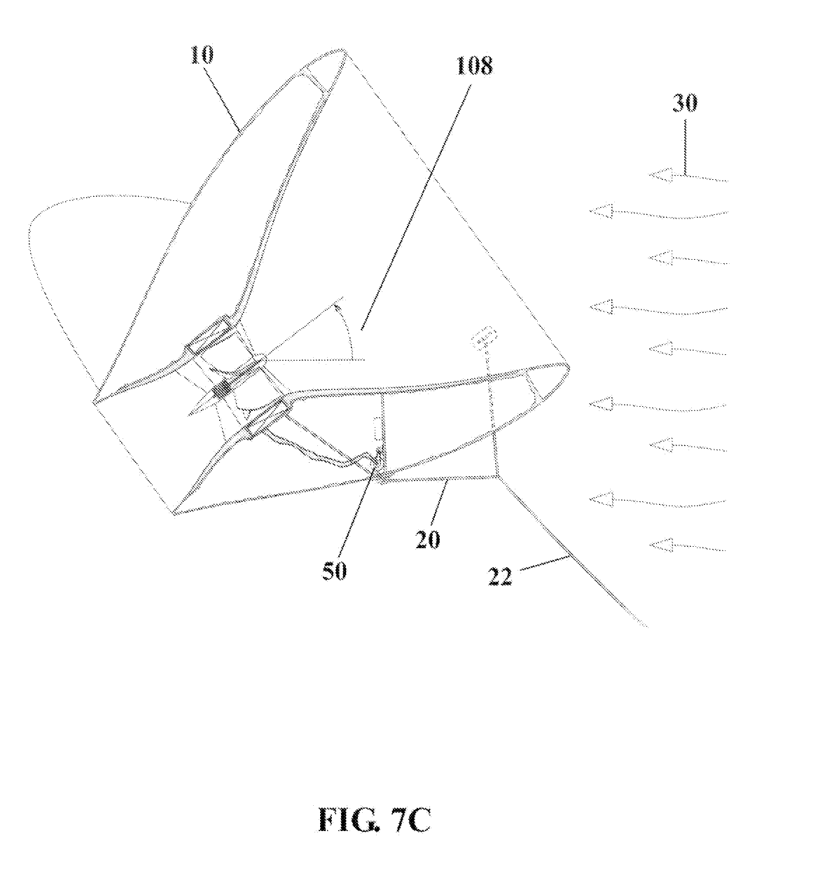

FIGS. 7A, 7B, and 7C are longitudinal cross-sectional views that show how pitch attitude of the tethered wind turbine interacts with the apparent wind. In FIG. 7A the aerodynamic shape of the inflated casing (10) is a ring-wing that is in a neutral angle of attack.

FIG. 7B shows the tethered wind turbine in a negative angle of attack (106). This maneuver is accomplished by various means. Shown in this view the harness pitch adjustor (50) has let out some length of the central line of the harness (20) causing the buoyant rear end of the inflated casing (10) to be moved upward relative to the front end. In this state the flying ring wing is going to descend. Another way to accomplish this negative angle of attack (106) is by using the aerodynamic control surfaces of the horizontal stabilizer (56) or the wing control surface (60).

Conversely, as is shown in FIG. 7C, the harness pitch adjustor (50) has pulled in the central line of the harness (20) causing the rear end of the inflated casing (10) to be moved downward relative to the front end. This positive angle of attack (108) would cause the flying ring-wing tethered wind turbine to ascend, and allow the energy harvesting turbine system to increase electrical output without as much loss of altitude. The higher loading of the turbine would mean more total drag on the impeller rotor (26), and a tendency to descend. This could be balanced-off or improved by calling for an even larger positive angle of attack (108) maneuver, and a tendency to ascend.

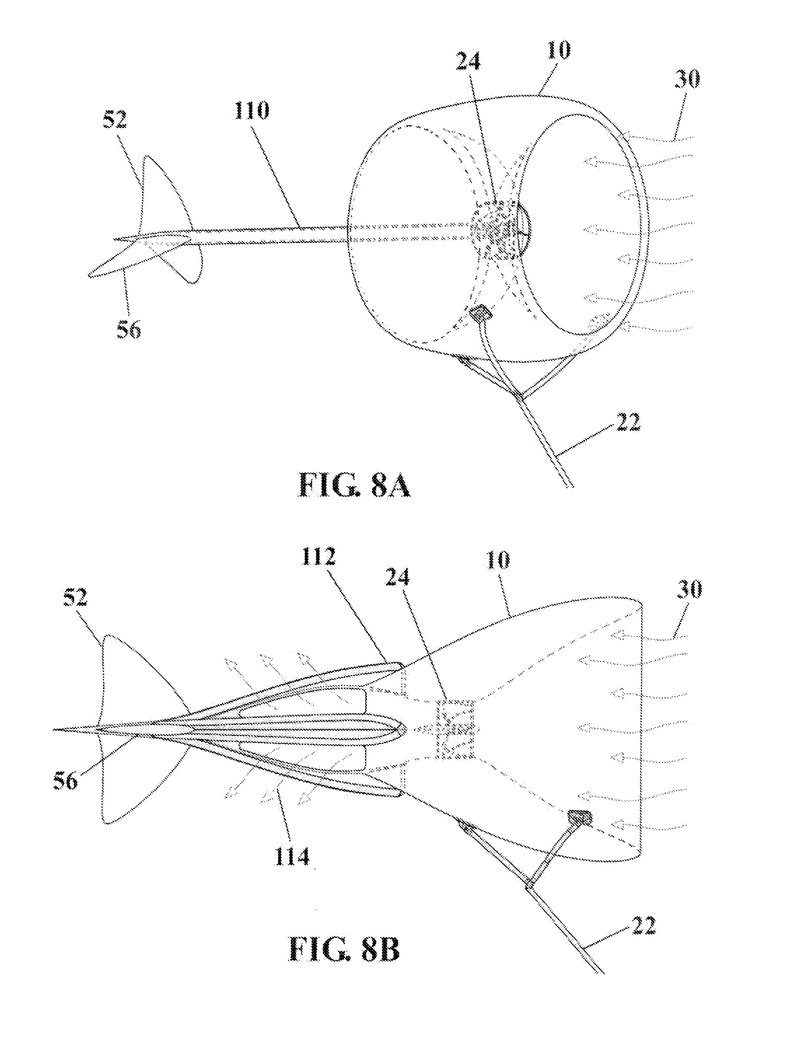

FIG. 8A is a perspective left-side view of the tethered wind turbine showing how in one embodiment of the invention a tubular tail boom (110) could be used to mount rear stabilizer wing surfaces.

FIG. 8B is a longitudinal cross-sectional view of the wind turbine of FIGS. 1 and 2, showing how the fluted tail section (112) could be built to allow outlet air (114) to exit through slots in the tail boom section itself.

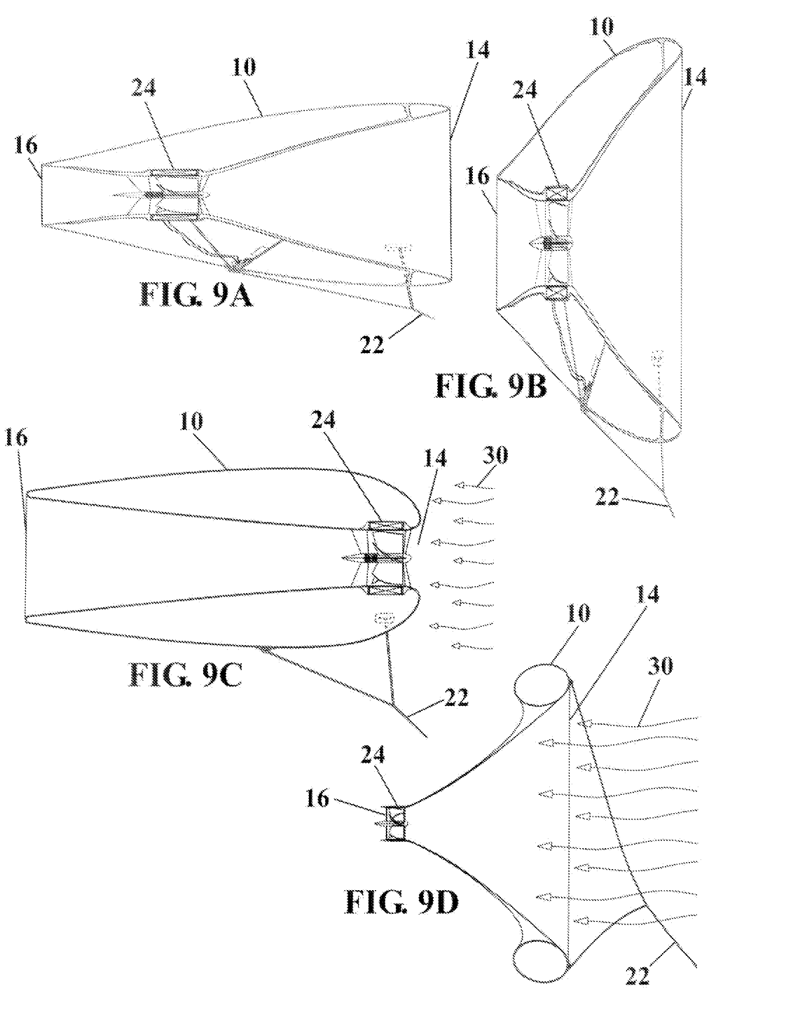

FIG. 9A shows a longitudinal cross-section of the wind turbine of FIGS. 1 and 2 that has a elongated profile of the airfoil-shaped inflated casing (10) of the invention. FIG. 9B is a potential shape that embraces a very short longitudinal airfoil profile of the inflated casing that may be efficacious due to its large annulus (12) outside diameter relative to its turbine diameter and air outlet (16) outside diameter. A prominent feature of this embodiment of the invention is the large concentration ratio of the front inlet (14) flow concentrator nozzle (32). It appears the concentration ratio is nearly 6 to 1, or higher. FIG. 9C shows almost the opposite inlet (14) style. That is, it shows a very minor attempt to concentrate the wind at the inlet (14) flow concentrator nozzle (32). The concentration ratio is nearly 1 to 1. FIG. 9D is a longitudinal cross-sectional view of yet a different section shape and construction style. In this view the bulk of the lifting gas (40) within the inflated casing (10) is located in the annulus (12) of the front inlet (14). The remainder of the flow concentrator nozzle (32) in this embodiment is analogous to a wind-sock, comprising a thin cone-shaped wall, whether of rigid or flexible material. As with a wind-sock, the cone-shape become more pronounced by the wind flowing through it, All of these gas inflated structures and many more could be designed and manufactured without materially or significantly diverging from the scope of this invention.

### REFERENCE NUMERALS

| | | | |
|---|---|---|---|
| 10 | inflated casing | 12 | annulus |
| 14 | inlet | 16 | outlet |
| 18 | attachment bracket | 20 | harness |
| 22 | tether | 24 | turbine |
| 26 | impeller rotor | 28 | electric generator |
| 30 | flowing fluid (air = wind, | 32 | flow concentrator |
| | water = current) | | |
| 34 | flow expansion nozzle | 36 | impeller rotor nose cone |
| 38 | impeller rotor tail cone | 40 | lifting gas |
| 42 | gas containment film | 44 | inflated toroid |
| | | | leading edge structure |
| 46 | internal structure | 48 | control module |
| 50 | harness pitch adjustor | 52 | vertical stabilizer |
| 54 | stabilizer control surface | 56 | horizontal stabilizer |
| 58 | wing | 60 | wing control surface |
| 62 | retractor control module | 64 | tether retractor mechanism |
| 66 | reel motor | 68 | base shelter structure |
| 70 | power conditioner box | 72 | robotic controlled torus |
| 74 | tether winding reel | 76 | generator output wires |
| 78 | cables-reel to power control | 80 | power output wires |
| | box | | |
| 82 | outer casing | 84 | main tensile member |
| 86 | positive conductor wire | 88 | negative conductor wire |
| 90 | conductor wire insulation | 92 | hinged bay door |
| 94 | pulley system | 96 | output plug box |
| 98 | site pad | 100 | wishbone launch arm |
| 102 | launch arm actuators | 104 | meteorological |
| | | | analysis module |
| 106 | negative angle of attack | 108 | positive angle of attack |
| 110 | tubular tail boom | 112 | fluted tail section |
| 114 | outlet air | | |

### Operation

### FIGS. 1, 2, 3, 4, 6, 7

FIG. 1 and FIG. 2 show the component of the tethered wind turbine invention that extracts energy from wind currents. The inflated casing (10) is filled with helium or other lifting gas (40) which makes the tethered wind turbine lighter than air. It also is shaped to scoop-up and aerodynamically force large amounts of air to move through its own interior. The inflated casing (10) is shaped like an airfoil wing that has been bent all the way around into a ring. At the front, a funnel-shaped inlet (14) is surrounded with an annulus (12) at the leading edge. Together they direct oncoming apparent wind into the central part of the ring-wing shape and into a smaller and smaller opening. The wind then passes into the mouth of a rotary engine turbine (24), and finally exits out the rear outlet (16) to return to the atmosphere.

### No Need for a Gearbox

The flow concentrator nozzle (32) gradually directs a large cross-sectional area of slower-moving air to a smaller cross-sectional area, but higher velocity duct full of air. The laws of aerodynamics say that air moving two times faster will carry eight times more energy. It is apparent that an aerodynamically shaped device that can concentrate and accelerate the apparent wind in a controlled manner will be very helpful in extracting energy from the wind. It is the intent of this invention to use the flow concentrator nozzle (32) to make a large cross-sectional area of slower-moving air to move through a smaller cross-sectional area at a higher velocity through the turbine (24). This reduces the size of the physical hardware of the turbine (24) and enables it to operate at a higher speed without the need for an up-ratio gear-box.

FIG. 3 shows that the turbine (24) is mounted centrally in the inflated casing (10). Air currents can flow through it imparting energy to the turbine (24). The kinetic energy of a flowing fluid (30), such as flowing wind or running water or the like, is converted into mechanical or electrical energy by causing the blades of the impeller rotor (26) on the turbine (24) to rotate as it passes through. Output of electrical energy harvested from the wind will be maximized when the wind throughput of the turbine is maximized. So every effort to streamline the interior surfaces is very important and has been attempted to be shown in this preferred embodiment of the invention.

### No Tower Needed

In most places on earth, the wind speed, and thus potential kinetic energy that could be harvested is distributed in a gradient relative to ground, which could be described as increasing as one moves to a higher altitude. Unlike most windmills currently available, the tethered wind turbine of this invention operates without a tower. It simply does not need a tower. The preferred embodiment of this invention uses a tether (22) to hold the inflated casing (10) and its turbine (24) from sailing downwind with the force of available winds.

### No Nacelle Needed

The tethered wind turbine also has no need for a complicated rotating nacelle as is currently used in the prior art to align properly with the direction of the true wind. The tethered wind turbine has a unique ability to keep itself aligned properly to the wind automatically, even in changing wind conditions. The inflated casing (10) will naturally drift to the most downwind position in the sky, being restrained only by the tether (22). Just like the rudder on an airplane, the invention directs itself in response to the changing wind's direction.

### Flying the Tethered Wind Turbine

FIG. 6A is a view looking downwind at the invention while it is operating. The tether (22) can be let-out, or pulled-in, in a controlled way so as to position the inflated casing (10) in the most favorable part of the natural wind velocity gradient. That is an altitude where the energy extracted from the wind can be maximized.

As is shown in FIG. 6A, 6B, 6C the tethered wind turbine invention uses a base shelter structure (68) to store the lighter-than-air device during inclement weather conditions, violent lightning, periods of non-use, or for routine maintenance.

FIG. 6A shows the tether (22) after it has been let out and the hinged bay doors (92) are closed. The retractor control module (62) remains idle while the production of energy aloft in the turbine (24) proceeds uninterrupted. The electrical power sent down the tether (22) travels through the tether retractor mechanism (64), through the reel-to-power box cables (78), and into the power conditioner box (70). At this stage the electricity is adjusted to a form that is compatible with the end user electrical specifications and exits the system through the output plug box (96).

FIG. 6B shows the tethered wind turbine in the middle stage of launching or retracting. At this stage the tether (22) is fully retracted, the wishbone launch arm (100) is in the upright position and the hinged bay doors (92) are wide open. If in launching mode, the tether (22) would be let out, the lighter-than-air inflated casing (10) would ascend slowly upward. If in the retracting stage, the robotic control torus (72) would rotate the inflated casing (10) until the craft aligned properly with the hinged bay doors (92) and then ready the system for final stage.

FIG. 6C shows the final stage of the tethered wind turbine when the inflated casing (10) is in the completely stored mode. The wishbone launch arm (100) is in the lowered and horizontal position resting underneath the inflated casing (10). The hinged bay doors (92) are closed and the entire system is in standby mode.

### Controlling the Tethered Wind Turbine

The preferred embodiment of the invention would have a smart logic circuitry built into it. The control module (48), shown in FIG. 3, would make many decisions about when, where and how to fly the tethered wind turbine. The onboard automatic-pilot feature of the control module (48) would send control voltage signals to various aerodynamic control mechanisms to tune the flight of the tethered wind turbine and thereby achieve a desired ascent trajectory and altitude.

At launch, there would be software programmed to fly the lighter-than-air tethered wind turbine in a controlled, stable ascent. The tethered wind turbine's ascension could be stable in zero-wind conditions, or, even in rough and gusty wind conditions. This auto-pilot feature to maintain straight and level flight during fluctuating of wind currents broadens the potential application to many geographic locations that otherwise may not have been feasible.

### Controlling the Angle of Attack

Controlling the angle of attack of the inflated casing (10) is essential for flight control. By controlling the angle of attack, the flying ring-wing-like tethered wind turbine would be able to ascend on command to a predetermined altitude to achieve the best position in a given environment. Once at the favorable altitude the tethered wind turbine would electronically load-up the electrical generator (28) to increase electrical output.

As shown in FIG. 7A, 7B, 7C one way this invention controls the angle of attack, the flight, and ultimately the altitude, of the inflated casing (10) is to change the characteristics of its attachment at the top of the tether (22). The attachment as shown in this embodiment of the invention utilizes a three-point flexible harness (20). It has a method to adjust it as so as to change the angle of attack and therefore the amount of lift on the inflated casing (10). It is the intent of this invention to use the tether's (22) harness pitch adjustor (50) device to vary the overall amount of lift on the inflated casing (10) and thereby control the altitude it operates at. The harness pitch adjustor (50) does this by extending or reeling-in the center rear harness tension member with a servo motor mechanism. By adjusting the harness (20) attachment in the above described way the overall angle of attack and hence the total lift of the ring-wing-like inflated casing (10) is controlled. The desired altitude is either dialed into the control module (48) or determined automatically by a software algorithm that takes into account several variables.

The benefit using the harness pitch adjustor (50) as envisioned in this invention to control angle of attack of the inflated casing (10), a larger amount of electrical output would be achieved with less loss of altitude. In the absence of any angle of attack flight controls such as the harness pitch adjustor (50), higher loading of the turbine (24) would mean increased drag on the blades of the impeller rotor (26), an increased total drag on the inflated casing (10), and a general tendency for it to descend. This suboptimal condition could be improved by the use of the harness pitch adjustor (50) of this invention, as described above.

There is one balance of forces that naturally occurs with the tethered wind turbine invention. If winds escalate while the invention is operating, the overall forces increase on the inflated casing (10). The natural reaction is for it to be drawn farther downwind and arc-tangentially lower according to the radius struck by the length of tether extended at that time. Other things remaining equal, the craft moves down to a lower altitude and hence a lower energy level in the natural wind velocity gradient. This will reduce forces on the inflated casing (10) and result in a convergence toward a natural equilibrium.

### Controlling the Generator

The control module (48) also sends control signals to the tethered wind turbine's electric generator (28) circuitry. For example, in favorable wind conditions the kinetic energy of the moving air flow develops lift on the turbine (24) blades, turning the impeller rotor (26) and electric generator (48). The only thing resisting the impeller rotor (26) turning motion is the amount of load, or field resistance, that the electric generator (28) demands at a given point in time. The load setting is a controllable variable that the control module (48) can monitor and adjust. The tethered wind turbine utilizes the generator loading configuration to maximize power output but at the same time retain adequate air stability and altitude. The more load levied on the impeller rotor (26), the more overall wind drag will be developed on the craft. The total induced drag on the lighter-than-air inflated casing (10) shows up as a tensile force on the tether (22) along a vector in the downwind direction. The tension in the tether (22) is resisted by a mass below. The control module (48) ideally should balance power output versus positional stability and drag management. The control module uses electronic hardware and software as is necessary to accomplish this goal.

### Control of Electrical Output

The control module (48) also may condition the electricity that is output by the electric generator (28). In may invert the voltage up to a higher voltage for the purpose of efficiently transferring the generated power down the tether (22) to the base shelter structure (68) below. There would be lower line losses experienced if the electricity traveling down the tether (22) were voltage-adjusted higher. The control module (48) would handle this function.

In summary, the control module (48) of the tethered wind turbine performs the following functions:
controls straight and level flight of the inflated casing (10) using aerodynamic control surfaces
controls straight and level flight of the inflated casing (10) using harness pitch adjustor (50)
controls load levels applied to electric generator (48)
converts or inverts voltages as necessary to optimize efficient energy transfer down the tether (22)

### Operation of Additional Embodiments

### FIG. 5

There are actually two ways this invention proposes to accomplish varying the angle of attack so as to control the flight and altitude of the inflated casing (10). The first way to would be to use automatic electrical control of the harness pitch adjustor (50) as described above.

In an additional embodiment of the invention, angle of attack would be controlled using additional wings, stabilizers and other aerodynamic control surfaces. The net affect would be increased control of total lift of the inflated casing (10) and an ability to control its altitude.

FIG. 5 shows one such additional embodiment of the tethered wind turbine invention using aerodynamic control surfaces of many types. These include any and all types of active or passive in-stream surfaces as are typically found on, but not limited to, conventional aircraft such as a horizontal stabilizer (56), vertical stabilizer (52), stabilizer control surface (54), and any type of wing (58), or wing control surface (60). It is unlikely that all of these would be necessary.

It is also the intent in this additional embodiment of the invention, for inflated casing (10) to use its aerodynamic surfaces to soar to higher heights than would otherwise be possible in an effort to counteract the craft's downward altitude tendency caused by power extraction induced drag of the turbine (24).

It should be noted that the inflated casing (10) of the tethered wind turbine could be secured to ground through a less sophisticated tether system and it will still be a valuable energy extracting machine in the sky. Or it could be outfitted to operate somewhat autonomously with its own internal smart-chip controller and sophisticated controls for its harness pitch adjustor or its aerodynamic wing control surfaces (60). The latter would probably come closer to maximizing energy production efficiency, but would likely cost more to manufacture. It is a trade-off. The tethered wind turbine invention as described in this document leaves room to cover both.

### Adapting to Weather

It is envisioned that an additional embodiment of the invention would have a micro-meteorological analysis module (104) onboard that could automatically obtain samples and or use sensors to collect enough data in real time to be able to judge the likelihood of lightning or other hazardous weather conditions. With knowledge of the meteorological facts, including but not limited to, data on humidity, precipitation, temperature, atmospheric pressure, the presence of ozone, or audio-visual signatures, the tethered wind turbine could be programmed to do certain things. It would run the data through a decision formula that could prompt actions such as immediately descending the inflated casing (10) to a safer altitude by reeling in the tether (22). Other times in truly inclement weather, it could fully retract the invention to the safety of the base shelter structure (68). This could all be done automatically and would prevent catastrophic failures as otherwise could be experienced from such hazards as lightning strikes, tornado-like wind currents, or destructive hail. The meteorological analysis module (104) could optionally be located in the base shelter structure (68) or other place not onboard the inflated casing (10).

### Operation of Alternative Embodiments FIGS. 8, 9

FIG. 8 A shows an alternative design of the tethered wind turbine that utilizes a very simple boom and rear stabilizer arrangement. It represents a direct and simple method of construction.

FIG. 8B shows another more fanciful arrangement where the exit of air from the turbine (24) is through a number of slots in the sidewalls of the tail structure.

FIG. 9A, 9B, 9C, and 9D show how the tethered wind turbine invention could still perform as explained above but with different ring-wing cross-sectional profiles. FIG. 9A is an elongated version of the preferred embodiment of this invention. FIG. 9B is a more exaggerated version with the turbine (24) located very near to the air outlet (16) and the flow concentrator nozzle (32) exhibiting a larger concentration of cross-sectional area ratio. FIG. 9C shows a profile that has the turbine (24) located near the leading edge annulus (12) with a very small concentration of cross-sectional area ratio. FIG. 9D is profile with most of the inflated part reserved to the front annulus (12) itself.

### ADVANTAGES OF THE TETHERED WIND TURBINE

It can be seen that the tethered wind turbine of this invention:
Provides a new way to extract the kinetic energy from the wind.
Allows use of a smaller, lighter-weight, higher-speed turbine generator that does not need for an expensive and bulky up-ratio gearbox between the impeller rotor (26) and the electric generator (28).
Operates without the need for a tower.
Has no need for a complicated rotating nacelle to align rotating blades with the wind.
Uses lift generated from its overall shape or from horizontal wings so that it can operate higher aloft than would otherwise be possible while extracting energy from the wind.
Has a control module that can monitor flight and weather variables and then react to control trajectory, position, stability, altitude, generator loading levels and power output.
Has the capacity to retract the tether (22) and inflated casing (10) to a lower altitude or ultimately all the way into the base shelter structure (68) to avoid damage from lightning or severe weather.

While embodiments of the present invention have been described with reference to the aforementioned applications, these descriptions of the embodiments are to be construed in a limiting sense. It shall be understood that all aspects of embodiments of the present invention are not limited to the specific depictions, configurations or dimensions set forth herein which depend upon a variety of principles and variables. Various modifications in form and detail of the disclosed apparatus, as well as other variations of the embodiments of the present invention, will be apparent to a person skilled in the art upon reference to the present disclosure. It is therefore contemplated that the appended claims shall cover any such modifications or variations of the described embodiments as falling within the true spirit and scope of the present invention.

What is claimed is:

1. A buoyant turbine machine for extracting energy, comprising:
a lighter-than-air device comprising an exterior skin, said exterior skin comprising a concentrating inlet and an outlet;
an energy converter attached to said lighter than air device; and
a tether attached to said lighter-than-air device; said lighter-than-air device to generate energy by concentrating air flow within said concentrating inlet and directing it through said energy converter.

2. The buoyant turbine machine of claim 1 further comprising a control module attached to said lighter-than-air device to control ascent and descent.

3. The buoyant turbine machine of claim 1 further comprising a control module attached to said lighter-than-air device to maintain stability and altitude.

4. The buoyant turbine machine of claim 3 wherein said control module maintains said stability and altitude automatically.

5. The buoyant turbine machine of claim 1 further comprising a control module attached to said lighter-than-air device to monitor and adjust load levels of said energy converter.

6. The buoyant turbine machine of claim 1 further comprising a control module attached to said lighter-than-air device to monitor and respond to meteorological data.

7. The buoyant turbine machine of claim 1 wherein said energy converter comprises a turbine coupled to an electrical generator.

8. The buoyant turbine machine of claim 7, wherein said turbine is coupled to said electrical generator employs electrolysis to generate hydrogen and oxygen.

9. The buoyant turbine machine of claim 8, wherein said generated hydrogen and oxygen are pumped down the tether.

10. The buoyant turbine machine of claim 9, wherein said tether is tubular.

11. The buoyant turbine machine of claim 1, wherein said tether is one of tubular and electromechanical.

12. The buoyant turbine machine of claim 1 wherein said lighter-than-air device is shaped to provide aerodynamic lift.

13. The buoyant turbine machine of claim 12 wherein said lift is actively controlled.

14. The buoyant turbine machine of claim 1 wherein said lighter-than-air device comprises a wing to provide aerodynamic lift.

15. The buoyant turbine machine of claim 14 wherein said lift is actively controlled.

16. The buoyant turbine machine of claim 1 wherein said lighter-than-air device is passively stable.

17. The buoyant turbine machine of claim 16, wherein said passively stable lighter-than-air device comprises at least one of an airfoil shape, a non-articulating horizontal stabilizer, a non-articulating vertical stabilizer, a non-articulating v-shaped stabilizer, and a non-articulating ring-wing stabilizer.

18. The buoyant turbine machine of claim 1 wherein said exterior skin comprises an actively-articulating aerodynamic control surface.

19. The buoyant turbine machine of claim 1 wherein said lighter-than-air device is attached to an adjustable pitch control harness.

20. The buoyant turbine machine of claim 1 wherein said tether comprises a carbon nanotube primary tensile strength member.

21. The buoyant turbine machine of claim 1 wherein said tether comprises a carbon nanotube electrical conducting member.

22. The buoyant turbine machine of claim 1 wherein the lighter-than-air device is at least partially constructed of Tedlar film.

23. The buoyant turbine machine of claim 1 wherein said exterior skin is aluminized polyester film.

24. The buoyant turbine machine of claim 1 wherein said wind turbine machine is attached to a base structure.

25. The buoyant turbine machine of claim 1 wherein said wind turbine machine is attached to a tether retractor mechanism.

26. A buoyant turbine machine for extracting energy, comprising:
a lighter-than-air ring-wing with a low-coefficient-of-drag section profile comprising an inlet, an annulus, said annulus comprising a funnel-like concentrator, and an outlet;
an energy converter attached to said ring-wing; and
a tether attached to said ring-wing; said lighter-than-air ring wing to generate energy by concentrating air flow within said concentrating inlet and directing it through said energy converter.

27. A buoyant turbine machine for extracting energy, comprising:
a lighter-than-water ring-wing with a low-coefficient-of-drag section profile comprising an inlet, an annulus, said annulus comprising a funnel-like fluid flow concentrator, and an outlet;
an energy converter attached to said lighter-than-water ring-wing; and
a tether attached to said lighter-than-water ring-wing; said lighter-than-water ring-wing to generate energy by concentrating water flow within said concentrating inlet and directing it through said energy converter.

28. The buoyant turbine machine of claim 27 wherein said lighter-than-water ring-wing is attached to a hydrodynamic control surface.

29. The buoyant turbine machine of claim 27 wherein said lighter-than-water ring-wing is attached to a hydrodynamic lift surface.

30. The buoyant turbine machine of claim 27 wherein said tether is attached to a pitch adjustor harness.

31. A buoyant turbine machine for extracting energy, comprising:
a device comprising an exterior skin, said exterior skin comprising a concentrating inlet and an outlet;
an energy converter attached to said device; and
a tether attached to said device; said device to generate energy by concentrating fluid flow within said concentrating inlet and directing it through said energy converter.
